(19) United States
(12) Patent Application Publication
(10) Pub. No.: US 2024/0253421 A1
(43) Pub. Date: Aug. 1, 2024

(54) SIMULATION DEVICE, SIMULATION METHOD, AND AIR CONDITIONING CONTROL SYSTEM

(71) Applicant: PANASONIC INTELLECTUAL PROPERTY MANAGEMENT CO., LTD., Osaka (JP)

(72) Inventors: Teppei EMURA, Osaka (JP); Fumitaka KIKUCHI, Osaka (JP); Naoya KITADE, Osaka (JP); Tatsuhiko NUMOTO, Osaka (JP); Makoto IYODA, Osaka (JP); Ryo MATSUBARA, Osaka (JP)

(73) Assignee: PANASONIC INTELLECTUAL PROPERTY MANAGEMENT CO., LTD., Osaka (JP)

(21) Appl. No.: 18/425,849

(22) Filed: Jan. 29, 2024

(30) Foreign Application Priority Data
Jan. 30, 2023 (JP) 2023-011879

(51) Int. Cl. B60H 1/00

(52) U.S. Cl. CPC B60H 1/0073; B60H 1/00771; B60H 1/00785

(57) ABSTRACT

A simulation device includes a communication interface configured to receive package information on a package in a vehicle and sensor information from at least one sensor attached to the vehicle, and a processor configured to execute air conditioning simulation using the received package information and sensor information and transmit an air conditioning control signal for controlling an air conditioner provided in the vehicle to the air conditioner.

### CROSS-REFERENCE TO RELATED APPLICATIONS

This application is based on and claims priority under 35 USC 119 from Japanese Patent Application No. 2023-011879 filed on Jan. 30, 2023, the contents of which are incorporated herein by reference.

### TECHNICAL FIELD

The present disclosure relates to an simulation device, a simulation method, and an air conditioning control system.

### BACKGROUND ART

WO2016/067421 discloses a cooling compartment capable of maintaining freshness of an object to be stored. The cooling compartment includes a cooling chamber, a cooling unit that cools air in the cooling chamber, and a fan that sends cold air cooled by the cooling unit to the cooling chamber. The cooling compartment further includes a temperature sensor that detects a temperature inside the cooling chamber, an infrared sensor that detects a temperature of an object to be stored placed in the cooling chamber, and a control unit that controls driving of the fan based on a detection result of at least one of the temperature sensor and the infrared sensor.

In recent years, with a development of physical distribution, there has been an increasing need to transport packages such as refrigerated products or frozen products. When transporting packages such as refrigerated products or frozen products, it is necessary to mount an air conditioning control device on a vehicle such as a truck and transport the packages at an optimum temperature.

In WO2016/067421, the cooling compartment controls air conditioning without considering information on a package in the cooling chamber. The information on the package is, for example, placement information of the package in the cooling chamber or information such as a type of the package. Therefore, there is a problem that in the cooling compartment according to WO2016/067421, control of air conditioning corresponding to the package cannot be executed.

The present disclosure has been made in view of the above-described situation in the related art, and an object thereof is to realize optimum cooling control corresponding to a loading state of a package.

### SUMMARY OF INVENTION

The present disclosure provides a simulation device including: a communication interface that receives package information on a package in a vehicle and sensor information from at least one sensor attached to the vehicle; and a processor that executes air conditioning simulation using the received package information and sensor information and transmits an air conditioning control signal for controlling an air conditioner provided in the vehicle to the air conditioner.

In addition, the present disclosure provides a simulation method including: receiving package information on a package in a vehicle and sensor information from at least one sensor attached to the vehicle; and executing air conditioning simulation using the received package information and sensor information and transmitting an air conditioning control signal for controlling an air conditioner provided in the vehicle to the air conditioner.

Further, the present disclosure provides an air conditioning control system including: a simulation device including a communication interface that receives package information on a package in a vehicle and sensor information from at least one sensor attached to the vehicle, and a processor that executes air conditioning simulation using the received package information and sensor information and optimizes an air conditioning control signal for controlling an air conditioner provided in the vehicle; and an air conditioning control device that controls the air conditioner based on the air conditioning control signal received from the simulation device.

These comprehensive or specific aspects may be implemented by a system, a device, a method, an integrated circuit, a computer program, or a recording medium, and may be implemented by any combination of the system, the device, the method, the integrated circuit, the computer program, and the recording medium.

According to the present disclosure, it is possible to realize optimum cooling control corresponding to the loading state of the package.

### BRIEF DESCRIPTION OF DRAWINGS

FIG. 1 is a diagram illustrating a first example of a vehicle on which an air conditioning control device is mounted;

FIG. 2 is a diagram illustrating a second example of the vehicle on which the air conditioning control device is mounted;

FIG. 3 is a block diagram of an air conditioning control system;

FIG. 4 is a block diagram of a supply chain management system;

FIG. 5 is a sequence diagram of a process of controlling air conditioning of the vehicle;

FIG. 6 is a flowchart of a process of analyzing loading information;

FIG. 7 is a flowchart of a process of calculating a control parameter;

FIG. 8 is a flowchart of a process of analyzing the loading information and the control parameter; and

FIG. 9 is a flowchart of a process related to whether execution of simulation is necessary.

### DESCRIPTION OF EMBODIMENTS

Hereinafter, embodiments that specifically disclose a simulation device, a simulation method, and an air conditioning control system according to the present disclosure will be described in detail with reference to the drawings as appropriate. However, more detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

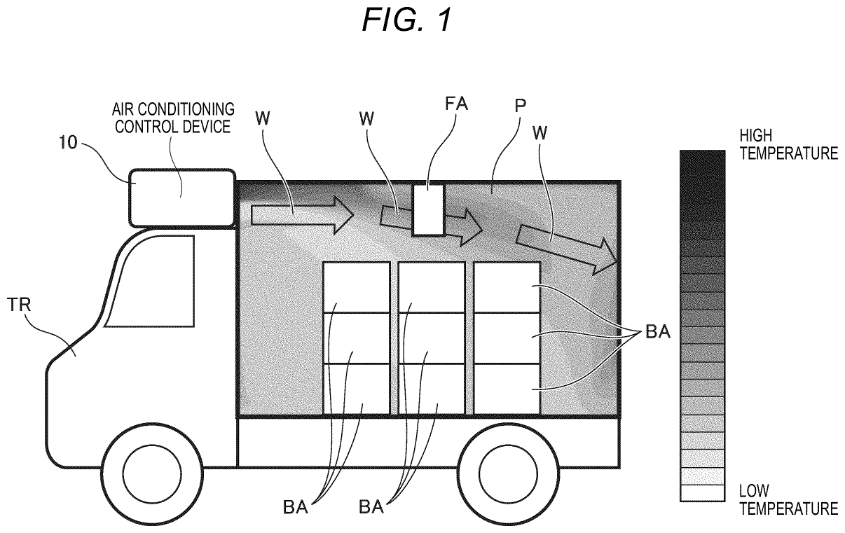

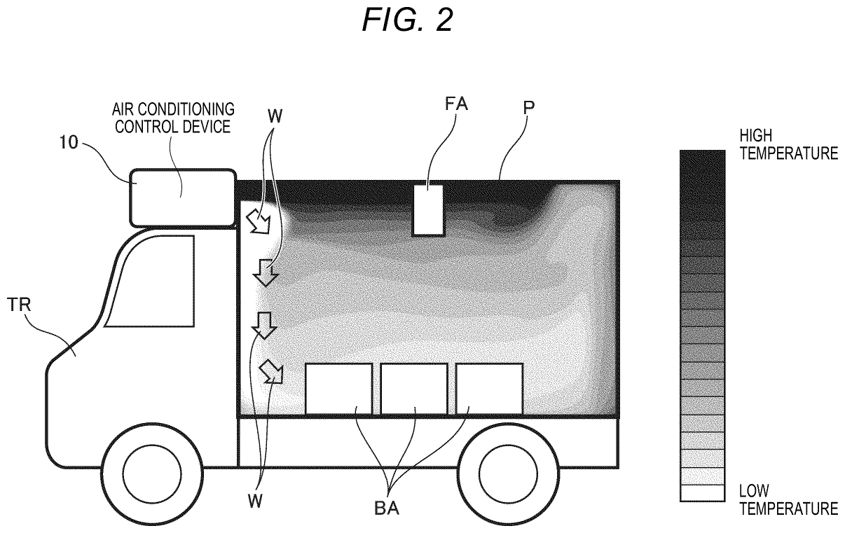

A vehicle TR on which an air conditioning control device 10 is mounted will be described with reference to FIGS. 1 and 2. FIG. 1 is a diagram illustrating a first example of the vehicle TR on which the air conditioning control device 10 is mounted. FIG. 2 is a diagram illustrating a second example of the vehicle TR on which the air conditioning control device 10 is mounted.

The vehicle TR is, for example, a vehicle for carrying packages such as a truck or a tractor for towing a trailer. In the present embodiment, the vehicle TR as a moving body is described as an example, but the present invention is not limited to the vehicle TR as long as it is a moving body. The vehicle TR has a package compartment P. The package compartment P is a space in which a plurality of packages BA can be loaded.

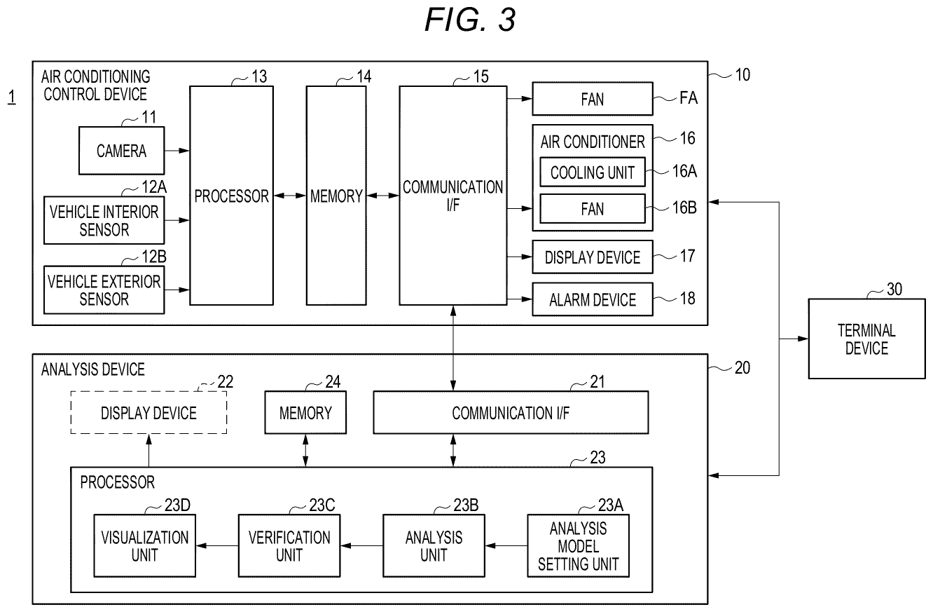

The vehicle TR is equipped with the air conditioning control device 10. The air conditioning control device 10 is installed, for example, above a driver's seat of the vehicle TR. An installation location of the air conditioning control device 10 in the vehicle TR is an example, and is not limited to above the driver's seat. The air conditioning control device 10 can control a temperature of the package compartment P by outputting wind W whose temperature, wind speed, and wind direction are controlled. Details of the air conditioning control device 10 will be described with reference to FIG. 3.

A fan FA is an electric fan or a circulator provided in the package compartment P. The fan FA is provided at any location in the package compartment P and is installed on, for example, a ceiling. The number of the fan FA is not limited to one, and a plurality of fans FA may be provided. The fan FA may normally operate, or may be communicably connected to the air conditioning control device 10 and operate based on a control signal from the air conditioning control device 10. In addition, the fan FA may be incorporated in the air conditioning control device 10 and controlled. The fan FA may be omitted from the package compartment P.

The package BA is a product requires temperature management such as a refrigerated product or a frozen product. The package BA is not particularly limited, and examples thereof include food, plants such as flowers, and pharmaceutical products. A plurality of packages BA loaded on the vehicle TR are not limited to objects requiring the temperature management, and objects requiring the temperature management and objects not requiring the temperature management may be loaded together.

A color of the package compartment P represents a temperature distribution, and the darker the color, the higher the temperature, and the lighter the color, the lower the temperature.

The example illustrated in FIG. 1 illustrates the vehicle TR in a case where the number of the packages BA is large and a ratio of the packages BA occupying the package compartment P is high. As an example, the air conditioning control device 10 executes control such that the wind W is output toward a rear side of the vehicle TR (that is, in a direction opposite to the driver's seat), and cools the entire package compartment P such that all of the plurality of packages BA are sufficiently cooled. In the example illustrated in FIG. 1, the temperature distribution of the package compartment P is substantially uniform and low as a whole.

On the other hand, the example illustrated in FIG. 2 illustrates the vehicle TR in a case where the number of packages BA is small and the ratio of the packages BA occupying the package compartment P is low. As an example, the air conditioning control device 10 executes control such that the wind W is provided on a lower side of the vehicle TR (that is, in the direction of gravity) and is output, and cools portions where the plurality of packages BA are placed to a sufficiently low temperature. In the example illustrated in FIG. 2, the temperature distribution of the package compartment P is a distribution in which the temperature is low on the lower side where the packages BA are placed and the temperature rises toward the upper side.

When the air conditioning control device 10 executes air conditioning without considering the number of packages BA placed in the package compartment P and the way to place the packages BA, there is a possibility that power more than necessary is consumed. In addition, there is a possibility that the air conditioning control device 10 cannot appropriately cool the packages BA and causes deterioration in quality of the packages BA. However, as in the examples illustrated in FIGS. 1 and 2, the air conditioning control device 10 executes air conditioning in accordance with the number of packages BA placed in the package compartment P and the way to place the packages BA, thereby realizing an optimum cooling environment for the packages BA. In FIGS. 1 and 2, air conditioning control that focuses on the number of packages and the way to place the packages has been described as an example, and hereinafter, air conditioning control in consideration of not only the number of packages and the way to place the packages but also a type and a management temperature of the packages, a temperature and humidity of the package compartment, a wind speed and a wind direction of output wind, a weather, solar radiation, and a temperature outside the vehicle, a transport route, a vehicle type, or the like of the vehicle is described.

Next, a block diagram of an air conditioning control system 1 will be described with reference to FIG. 3. FIG. 3 is a block diagram of the air conditioning control system 1.

The air conditioning control system 1 includes the air conditioning control device 10, a simulation device 20, and a terminal device 30.

The air conditioning control device 10 is a device that controls air conditioning of the package compartment P of the vehicle TR. The air conditioning control device 10 may be retrofitted to a cooling device mounted in advance on the vehicle TR, or may be incorporated in the cooling device of the vehicle TR in advance. The air conditioning control device 10 includes a camera 11, a vehicle interior sensor 12A, a vehicle exterior sensor 12B, a processor 13, a memory 14, a communication I/F 15, a fan FA, an air conditioner 16, a display device 17, and an alarm device 18.

The camera 11 captures an image of the package compartment P. The number of the camera 11 is not limited to one, and a plurality of cameras 11 may be installed so as to sufficiently capture images of the packages BA loaded in the package compartment P. The camera 11 is a visible light camera or an infrared camera. An illumination such as a fluorescent lamp, a light-emitting diode (LED) lamp, or an infrared lamp may be attached to the package compartment P so that the camera 11 can capture an image of the package compartment P. The illumination may be normally turned on, or may be controlled by the processor 13 so as to be turned on when the camera 11 captures an image. In addition, the illumination may be incorporated in the camera 11, and may be activated at the same time when the camera 11 captures an image to illuminate the package compartment P. The camera 11 includes at least a lens (not illustrated) as an optical element and an image sensor (not illustrated). The lens receives light reflected from an object within an angle of view of a region captured by the camera 11, and forms an optical image of the object on a light receiving surface (in other words, an imaging surface) of the image sensor. The image sensor is, for example, a solid state image sensor such as a CCD or a CMOS. The image sensor converts the optical image formed on the imaging surface via the lens into an electric signal every predetermined time period (for example, 1/30 (second)). For example, when the predetermined time is 1/30 (second), a frame rate of the camera 11 is 30 fps. In addition, the camera 11 may generate image data or video data by executing predetermined signal processing on the electric signal every predetermined time period described above. The camera 11 outputs the image data or the video data (hereinafter, referred to as a captured image) to the processor 13.

The vehicle interior sensor 12A measures an environment in the package compartment P. In addition, the vehicle interior sensor 12A acquires position information of the vehicle TR. The vehicle interior sensor 12A measures, for example, a temperature, humidity, a wind speed of wind output from the air conditioner 16, or a wind direction of the wind output from the air conditioner 16 as the environment in the package compartment P. The vehicle interior sensor 12A includes a sensor using a temperature sensor, a humidity sensor, a wind speed sensor, a wind direction sensor, a global positioning system (GPS), and the like. The vehicle interior sensor 12A is communicably connected to the processor 13. The vehicle interior sensor 12A outputs, to the processor 13, information on the temperature, the humidity, the wind speed, and the wind direction in the package compartment P and position information of the vehicle TR. Hereinafter, the information on the temperature, the humidity, the wind speed, and the wind direction is collectively referred to as air conditioning information.

The vehicle exterior sensor 12B measures solar radiation, a temperature, and the like as an environment outside the vehicle. Hereinafter, information on the solar radiation and the temperature is collectively referred to as weather information. The vehicle exterior sensor 12B includes a solar radiation sensor, a temperature sensor, and the like. The vehicle exterior sensor 12B is communicably connected to the processor 13. The vehicle exterior sensor 12B outputs the weather information to the processor 13.

The processor 13 is, for example, a central processing unit (CPU), a digital signal processor (DSP), a graphical processing unit (GPU), or a field programmable gate array (FPGA). The processor 13 functions as a controller that controls the overall operation of the air conditioning control device 10. The processor 13 executes control processing for governing operations of respective units of the air conditioning control device 10, input and output processing of data between the processor 13 and the respective units of the air conditioning control device 10, calculation processing of data, and storage processing of data. The processor 13 operates according to a program stored in the memory 14. The processor 13 uses the memory 14 during the operation, and temporarily stores data generated or acquired by the processor 13 in the memory 14. The processor 13 transmits the captured image acquired from the camera 11, the air conditioning information and the position information acquired from the vehicle interior sensor 12A, and the weather information acquired from the vehicle exterior sensor 12B to the memory 14 or the communication I/F 15.

The memory 14 is implemented using, for example, a random access memory (RAM) and a read only memory (ROM), and temporarily holds a program necessary for the operation of the air conditioning control device 10 and data generated during the operation. The RAM is, for example, a work memory used during the operation of the air conditioning control device 10. The ROM stores and holds in advance, for example, a program for controlling the air conditioning control device 10. The memory 14 may temporarily store the captured image, the air conditioning information, the position information, and the weather information received from the processor 13.

The communication I/F 15 is an interface circuit that executes wireless or wired communication between the air conditioning control device 10 and the simulation device 20 and between the air conditioning control device 10 and the terminal device 30. Here, I/F represents an interface. Communication between the air conditioning control device 10 and the simulation device 20 and communication between the air conditioning control device 10 and the terminal device 30 may be executed via a network. Examples of a communication method by the communication I/F 15 include mobile communication such as a wide area network (WAN), a local area network (LAN), a long term evolution (LTE), and 5G, power line communication, near field communication (for example, Bluetooth (registered trademark) communication), or communication for mobile phones.

The fan FA is an electric fan, a circulator, or the like that is provided in the package compartment P and circulates air in the package compartment P. The fan FA is controlled based on a control signal acquired from the communication I/F 15. For example, the fan FA is controlled based on a control signal transmitted from the simulation device 20 based on information (hereinafter, referred to as loading information) regarding how the plurality of packages BA analyzed by the simulation device 20 are arranged and loaded in the package compartment P. The loading information includes information such as a height of the loaded packages BA, a position of each package BA in the package compartment P, the number of packages BA, a ratio of the packages BA occupying the package compartment P, and a location where the package BA exists and a location where the package BA does not exist in the package compartment P. The loading information is table data, matrix data, two-dimensional image data, three-dimensional image data, computer-aided design (CAD) data, or the like in which the above-described various types of information are summarized. The fan FA is controlled to, for example, operate in a case where the height of the packages BA is equal to or higher than a predetermined threshold value, operate in a case where the ratio of the packages BA occupying the package compartment P is equal to or greater than a predetermined threshold value, or operate depending on a location where the package BA is placed (for example, a predetermined distance or more from the air conditioner 16). The fan FA may be manually switched on and off by a user such as a driver.

The air conditioner 16 is a device that executes air conditioning of the package compartment P. The air conditioner 16 includes a cooling unit 16A and a fan 16B. The cooling unit 16A is, for example, a compressor or a chiller. The air conditioner 16 outputs, to the package compartment P, wind whose temperature is conditioned by combining the cooling unit 16A and the fan 16B. The air conditioner 16 executes the air conditioning based on the control signal received from the communication I/F 15. The control signal is a signal analyzed by the simulation device 20, and is a control parameter relating to the temperature, the humidity, the wind speed, and the wind direction of the wind output from the air conditioner 16. In addition, the control parameter may include a parameter for controlling the fan FA. A simulation method for the control parameter will be described in detail later.

The display device 17 displays the loading information. The display device 17 displays, as the loading information, two-dimensional image data, text data, three-dimensional image data, or a screen on which the two-dimensional image data, the text data, and the three-dimensional image data are combined. The display device 17 may display not only the loading information but also the air conditioning information, the weather information, and the like. The display device 17 is, for example, a display or a touch panel display. In a case where the display device 17 is a touch panel display, an operation of switching information to be displayed may be executed, or information on the package BA (for example, information on a package loaded on the vehicle or a package taken out from the vehicle) may be input. A function of the display device 17 may be substituted by the terminal device 30, and the display device 17 may be omitted.

The alarm device 18 is a device that notifies an abnormality. Examples of a content of the abnormality include that: the way to place the packages BA is different from the loading information; the lens of the camera 11 is blocked by the packages BA and cannot be imaged; the air conditioner 16 is broken down; an abnormality occurs in temperature due to, for example, that a door of the package compartment P is open; and the package BA moves during transportation and is not in an optimum cooling state. The alarm device 18 is, for example, a speaker, and when an abnormality occurs, the alarm device 18 makes a beep sound or outputs a content of the abnormality by voice. In addition, the alarm device 18 may be a lamp, and the lamp is turned on or blinked when an abnormality occurs. The content of the abnormality is not limited to be output from the alarm device 18 and may be notified to the display device 17.

The simulation device 20 calculates the loading information and the control parameter of the package BA. The simulation device 20 is a server, a personal computer, or the like. The simulation device 20 includes a communication I/F 21, a display device 22, a processor 23, and a memory 24.

The communication I/F 21 is an interface circuit that executes wireless or wired communication between the air conditioning control device 10 and the simulation device 20 and between the simulation device 20 and the terminal device 30. Communication between the air conditioning control device 10 and the simulation device 20 and communication between the simulation device 20 and the terminal device 30 may be executed via a network. Examples of a communication method by the communication I/F 21 include mobile communication such as WAN, LAN, LTE, and 5G, power line communication, near field communication (for example, Bluetooth (registered trademark) communication), or communication for mobile phones. The communication I/F 21 acquires the air conditioning information, the position information, the weather information, and the captured image from the air conditioning control device 10 and outputs those to the processor 23. In addition, the communication I/F 21 outputs loading information and a control parameter analyzed by the processor 23 to the communication I/F 15.

The display device 22 displays contents analyzed by the processor 23 (for example, the control parameter, the loading information, and the like). The display device 22 is, for example, a display. The display device 22 may be omitted.

The processor 23 is, for example, a CPU, a DSP, a GPU, or a FPGA. The processor 23 functions as a controller that controls the overall operation of the simulation device 20. The processor 23 executes control processing for governing operations of respective units of the simulation device 20, input and output processing of data between the processor 23 and the respective units of the simulation device 20, calculation processing of data, and storage processing of data. The processor 23 operates according to a program stored in the memory 24. The processor 23 uses the memory 24 during the operation, and temporarily stores data generated or acquired by the processor 23 in the memory 24. The processor 23 implements functions of a simulation model setting unit 23A, a simulation unit 23B, a verification unit 23C, and a visualization unit 23D by using the program and data stored in the memory 24.

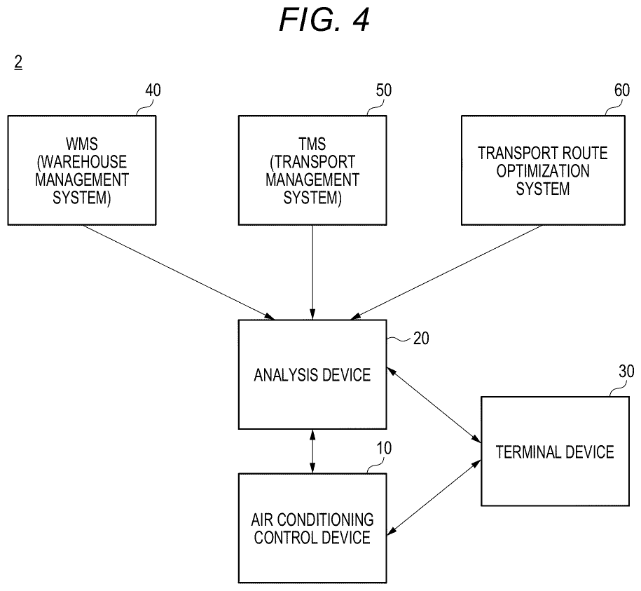

The simulation model setting unit 23A sets, as a simulation model, information on the package compartment P in which the packages BA used for simulation is loaded and the package BA. The information on the package compartment P is, for example, information such as a shape of the package compartment P or a width, a height, and a depth of the package compartment P. The information on the package BA is, for example, information such as the number of packages BA, a size of each package BA, and a management temperature of the package BA. The simulation model setting unit 23A may acquire the information on the package compartment P from a captured image of the camera 11 using a known technique such as image recognition. In addition, the simulation model setting unit 23A may acquire the information of the package compartment P from a TMS 50 (see FIG. 4). Note that TMS is an abbreviation for transport management system. The simulation model setting unit 23A acquires the information on the package BA from the terminal device 30 or a WMS 40 (see FIG. 4). Note that WMS is an abbreviation for warehouse management system.

The simulation unit 23B analyzes the control parameter and the loading information using the simulation model set by the simulation model setting unit 23A, the air conditioning information, the position information, the weather information, and the like. In addition, the simulation unit 23B may acquire the information on the package BA (hereinafter, referred to as package information) from the WMS 40 (see FIG. 4), information on the transport route (hereinafter, referred to as transport route information) from a transport route optimization system 60 (see FIG. 4), and information on the vehicle TR (hereinafter, referred to as vehicle information) from the TMS 50 (see FIG. 4) and analyze the loading information. The simulation unit 23B analyzes the control parameter and the loading information by using a known technique such as artificial intelligence (AI).

The verification unit 23C verifies whether the control parameter calculated by the simulation unit 23B and the analyzed new loading information are optimum. The verification unit 23C executes optimization processing using the analyzed control parameter and loading information, and optimizes the control parameter and the loading information.

The visualization unit 23D creates an image from which a result can be confirmed, or a screen to be displayed on the display device 17, the display device 22, or the terminal device 30, based on the loading information optimized by the verification unit 23C.

The terminal device 30 is a terminal device communicably connected to the air conditioning control device 10 and the simulation device 20. The terminal device 30 is, for example, a smartphone or a touch panel display. The terminal device 30 displays the loading information transmitted from the air conditioning control device 10 or the simulation device 20. For example, the terminal device 30 is owned by a person (hereinafter, referred to as a user) who performs loading such as a driver, and the user can perform the loading based on the loading information displayed on the terminal device 30. In addition, for example, the terminal device 30 may be able to input information on a package loaded on the vehicle TR or a package taken out when arriving at a target point (for example, a warehouse or a store) in the transport route.

Next, a block diagram of a supply chain management system 2 will be described with reference to FIG. 4. FIG. 4 is a block diagram of the supply chain management system 2.

The supply chain management system 2 includes the WMS 40, the TMS 50, the transport route optimization system 60, the simulation device 20, the air conditioning control device 10, and the terminal device 30.

The WMS 40 is a warehouse management system. The warehouse management system is a system using a known technique for collectively managing inventory information in a warehouse in which packages are stored. The WMS 40 is a system that manages information on delivery and shipment of the packages, position information on the packages in the warehouse, package information (for example, a size, a type, a transport destination, a management temperature, and the like of the packages), and the like. The WMS 40 transmits the information on the package loaded on the vehicle TR to the simulation device 20.

The TMS 50 is a transport management system. The transport management system is a system that uses a known technique for establishing an arrangement and a plan for vehicles required to transport packages. The TMS 50 transmits information on a vehicle type of the vehicle TR to the simulation device 20. The information on the vehicle type of the vehicle TR includes information on a shape and a size of the package compartment P.

The transport route optimization system 60 is a system that calculates an optimum transport route using a known technique such as AI. The transport route optimization system 60 calculates the transport route using a transport location of the vehicle TR, road information, information on a transport deadline of each package BA, and the like, and transmits the transport route to the simulation device 20.

In the supply chain management system 2, by cooperating with the WMS 40, the TMS 50, and the transport route optimization system 60, the simulation device 20 can analyze optimum loading information in consideration of the transport route of the vehicle TR, the information on the vehicle type of the vehicle TR, and the package information. The simulation device 20 can cause the air conditioning control device 10 to execute optimum air conditioning control by calculating the control parameter using the loading information. Hereinafter, a process of calculating the loading information and the control parameter of the simulation device 20 in the supply chain management system 2 will be described in detail.

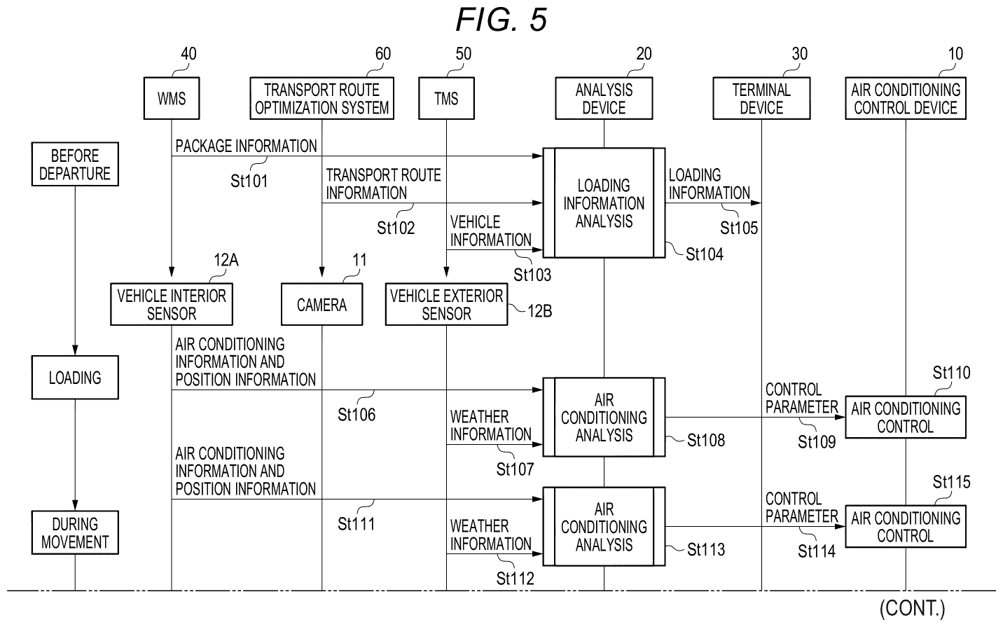

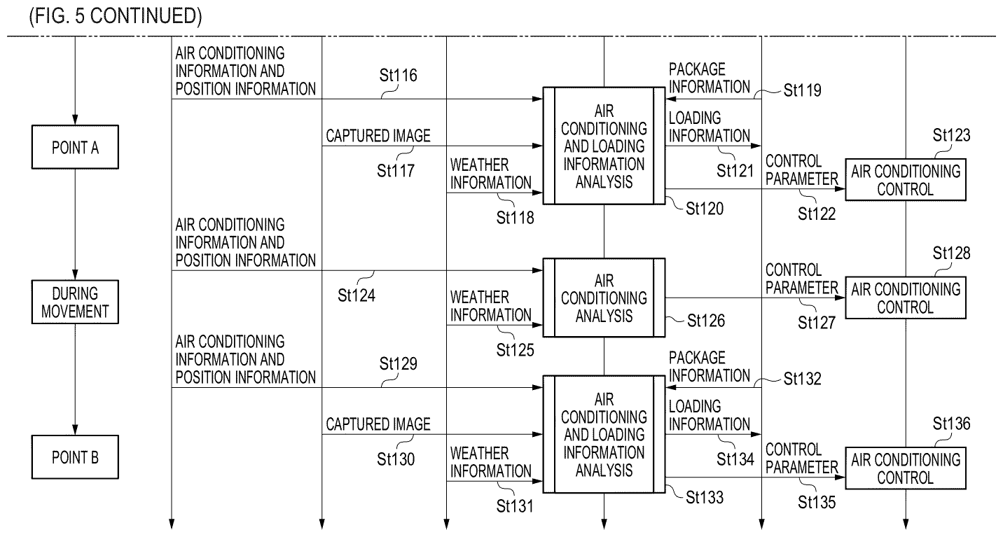

Next, an example of a process of controlling air conditioning of the vehicle TR will be described with reference to FIG. 5. FIG. 5 is a sequence diagram of the process of controlling the air conditioning of the vehicle TR. A flow of a process of the supply chain management system 2 illustrated in FIG. 5 is an example, and the present invention is not limited thereto.

First, a flow of the process of the supply chain management system 2 before the vehicle TR executes transportation (that is, before departure) will be described.

The WMS 40 transmits the package information to the simulation device 20 (step St101). The transport route optimization system 60 transmits the transport route information to the simulation device 20 (step St102). The TMS 50 transmits the vehicle information to the simulation device 20 (step St103).

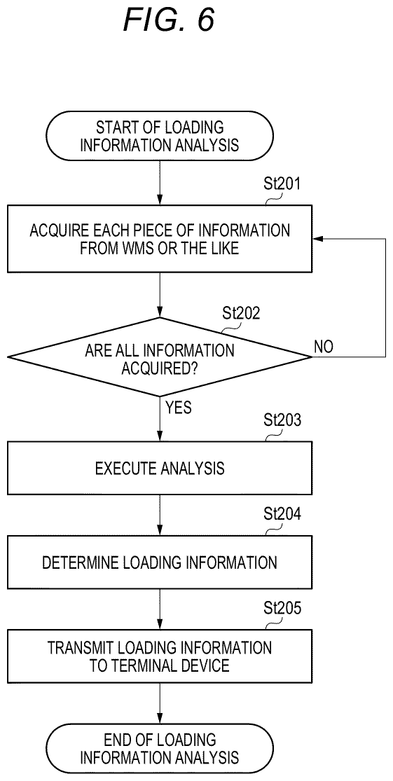

The simulation device 20 executes simulation of the loading information (hereinafter, referred to as loading information simulation) using the package information, the transport route information, and the vehicle information acquired in the processes of step St101, step St102, and step St103 (step St104). The loading information simulation executed by the simulation device 20 will be described with reference to FIG. 6. The simulation device 20 outputs the loading information analyzed in the process of step St104 to the terminal device 30 (step St105).

Next, a flow of the process of the supply chain management system 2 when loading the package BA on the vehicle TR will be described.

The vehicle interior sensor 12A transmits air conditioning information such as room temperature and humidity of the package compartment P and position information of the vehicle TR to the simulation device 20 (step St106). The vehicle exterior sensor 12B transmits the weather information to the simulation device 20 (step St107).

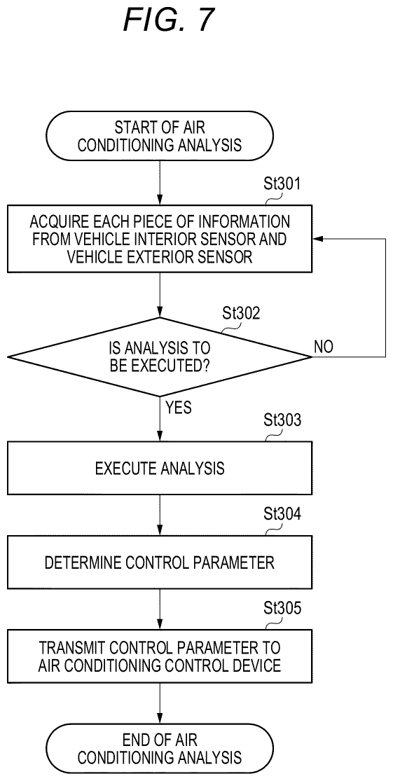

The simulation device 20 calculates the control parameter using the loading information analyzed in the process of step St104, the air conditioning information and the position information acquired in the process of step St106, and the weather information acquired in the process of step St107 (step St108). Hereinafter, the process of calculating the control parameter by the simulation device 20 is referred to as air conditioning simulation. The air conditioning simulation executed by the simulation device 20 will be described with reference to FIG. 7. The simulation device 20 may determine whether information on temperature has been acquired from the vehicle interior sensor 12A before the process of step St108 is executed. When it is determined that the information on temperature has not been acquired from the vehicle interior sensor 12A, the simulation device 20 executes a process of acquiring the information on temperature from the vehicle interior sensor 12A. When it is determined that the information on temperature has been acquired from the vehicle interior sensor 12A, the simulation device 20 may execute the process of step St108. The simulation device 20 transmits the control parameter calculated in the process of step St108 to the air conditioning control device 10 (step St109).

The air conditioning control device 10 executes air conditioning control for controlling the air conditioner 16 based on the control parameter received in the process of step St109 (step St110). As the air conditioning control executed by the air conditioning control device 10, for example, the air conditioning control device 10 adjusts the temperature, the wind speed, and the wind direction of the wind from the air conditioner 16. The air conditioning control device 10 may control the fan FA based on the control parameter. For example, control of the fan FA executed by the air conditioning control device 10 is control of turning on and off the fan FA, control of a rotation speed per unit time of the fan FA, or control of determining, when there are a plurality of fans FA, a fan FA to be operated among the plurality of fans FA.

Next, a flow of the process of the supply chain management system 2 during movement of the vehicle TR from a starting point to a point A will be described.

The vehicle interior sensor 12A transmits, to the simulation device 20, the position information of the vehicle TR and the air conditioning information including the room temperature and the humidity of the package compartment P and the wind speed and the wind direction of the wind output from the air conditioner 16 (step St11). The vehicle exterior sensor 12B transmits the weather information to the simulation device 20 (step St112).

The simulation device 20 executes air conditioning simulation using the loading information analyzed in the process of step St104, the air conditioning information and the position information acquired in the process of step St11, and the weather information acquired in the process of step St112 (step St113).

The simulation device 20 transmits the control parameter calculated in the process of step St113 to the air conditioning control device 10 (step St114).

The air conditioning control device 10 executes the air conditioning control for controlling the air conditioner 16 based on the control parameter received in the process of step St114 (step St115).

Next, a flow of the process of the supply chain management system 2 when the vehicle TR arrives at the point A will be described. The point A is a transport destination store, a transport destination residence, a warehouse, or the like. It is assumed that the vehicle TR unloads a part or all of the packages BA or newly loads a package BA at the point A. That is, it is assumed that a situation of the packages BA in the package compartment P of the vehicle TR changes at the point A.

The vehicle interior sensor 12A transmits, to the simulation device 20, the position information of the vehicle TR and the air conditioning information including the room temperature and the humidity of the package compartment P and the wind speed, the wind direction, and the like of the wind output from the air conditioner 16 (step St116). The camera 11 transmits a captured image to the simulation device 20 (step St117). The vehicle exterior sensor 12B transmits the weather information to the simulation device 20 (step St118).

The terminal device 30 receives, from the user, an input of the package information of the packages taken out from the vehicle TR or loaded on the vehicle TR. The terminal device 30 transmits the package information to the simulation device 20 (step St119).

The simulation device 20 executes simulation of the control parameter and the loading information (hereinafter, referred to as air conditioning and loading information simulation) using the various types of information acquired in the processes of step St116, step St117, step St118, and step St119 (step St120). Regarding the captured image acquired in the process of step St117 and the package information acquired in the process of step St119, in a case where the package information can be acquired from the captured image using a known technique such as image recognition, the simulation device 20 may acquire only one of the captured image and the package information and execute the process of step St120.

The simulation device 20 transmits the loading information analyzed in the process of step St120 to the terminal device 30 (step St121). Accordingly, the simulation device 20 can support the user to change a layout of the packages BA to a state suitable for cooling by referring to the loading information.

The simulation device 20 transmits the control parameter calculated in the process of step St120 to the air conditioning control device 10 (step St122).

The air conditioning control device 10 executes the air conditioning control for controlling the air conditioner 16 based on the control parameter received in the process of step St122 (step St123).

Next, a flow of the process of the supply chain management system 2 during movement of the vehicle TR from the point A to a point B will be described.

The vehicle interior sensor 12A transmits, to the simulation device 20, the position information of the vehicle TR and the air conditioning information including the room temperature and the humidity of the package compartment P and the wind speed, the wind direction, and the like of the wind output from the air conditioner 16 (step St124). The vehicle exterior sensor 12B transmits the weather information to the simulation device 20 (step St125).

The simulation device 20 executes air conditioning simulation using the loading information analyzed in the process of step St104, the air conditioning information and the position information acquired in the process of step St124, and the weather information acquired in the process of step St125, and calculates a control parameter (step St126). The simulation device 20 transmits the control parameter calculated in the process of step St126 to the air conditioning control device 10 (step St127).

The air conditioning control device 10 executes the air conditioning control for controlling the air conditioner 16 based on the control parameter received in the process of step St127 (step St128).

Next, a flow of the process of the supply chain management system 2 when the vehicle TR arrives at the point B will be described. The point B is a transport destination store, a transport destination residence, a warehouse, or the like. It is assumed that the vehicle TR unloads a part or all of the packages BA or newly loads a package BA at the point B. That is, it is assumed that a situation of the packages BA in the package compartment P of the vehicle TR changes at the point B.

The vehicle interior sensor 12A transmits, to the simulation device 20, the position information of the vehicle TR and the air conditioning information including the room temperature and the humidity of the package compartment P and the wind speed, the wind direction, and the like of the wind output from the air conditioner 16 (step St129). The camera 11 transmits a captured image to the simulation device 20 (step St130). The vehicle exterior sensor 12B transmits the weather information to the simulation device 20 (step St131).

The terminal device 30 receives, from the user, an input of the package information of the packages taken out from the vehicle or loaded on the vehicle TR. The terminal device 30 transmits the package information to the simulation device 20 (step St132).

The simulation device 20 executes simulation of the control parameter and the loading information (hereinafter, referred to as air conditioning and loading information simulation) using the various types of information acquired in the processes of step St129, step St130, step St131, and step St132 (step St133). Regarding the captured image acquired in the process of step St130 and the package information acquired in the process of step St132, in a case where the package information can be acquired from the captured image using a known technique such as image recognition, the simulation device 20 may acquire only one of the captured image and the package information and execute the process of step St133.

The simulation device 20 transmits the loading information analyzed in the process of step St133 to the terminal device 30 (step St134). Accordingly, the simulation device 20 can support the user to change a layout of the packages BA to a state suitable for cooling by referring to the loading information.

The simulation device 20 transmits the control parameter calculated in the process of step St134 to the air conditioning control device 10 (step St135).

The air conditioning control device 10 executes the air conditioning control for controlling the air conditioner 16 based on the control parameter received in the process of step St135 (step St136).

As described above, the supply chain management system 2 calculates the control parameter each time in consideration of the air conditioning information, the weather information, the position information, the package information, and the like during transportation, thereby realizing optimum air conditioning control during transportation.

Next, a process of analyzing the loading information will be described with reference to FIG. 6. FIG. 6 is a flowchart of the process of analyzing the loading information. Each process of the flowchart in FIG. 6 is executed by the simulation device 20. In addition, the flowchart in FIG. 6 is an example of the process of the “loading information simulation” in FIG. 5.

The simulation device 20 acquires package information from the WMS 40, acquires vehicle information from the TMS 50, and acquires transport route information from the transport route optimization system 60, respectively (step St201).

The simulation device 20 determines whether all the package information, vehicle information, and transport route information are acquired (step St202).

When it is determined that all the information has not been acquired (NO in step St202), the simulation device 20 executes the process of step St201 again.

When it is determined that all the information are acquired (YES in step St202), the simulation device 20 executes simulation of the optimum loading information using the information acquired in the process of step St201 (step St203). Specifically, the simulation executed by the simulation device 20 in the process of step St203 is to analyze the loading information by the simulation unit 23B using the information acquired in the process of step St201 and to optimize the loading information analyzed by the verification unit 23C.

The simulation device 20 determines the loading information based on a simulation result of the process of step St203 (step St204).

The simulation device 20 transmits the loading information determined in the process of step St204 to the terminal device 30 (step St205).

Accordingly, the simulation device 20 can analyze the optimum loading information in consideration of a transport distance of each vehicle TR, a management temperature of the package, a size of the package compartment, and the like by using the package information, the vehicle information, and the transport route information. In addition, since the analyzed optimum loading information can be shown to the user, it is possible to reduce labor of the user in a work of carrying in the package.

Next, a process of calculating a control parameter will be described with reference to FIG. 7. FIG. 7 is a flowchart of the process of calculating the control parameter. Each process of the flowchart in FIG. 7 is executed by the simulation device 20. In addition, the flowchart in FIG. 7 is an example of the process of the “air conditioning simulation” in FIG. 5.

The simulation device 20 acquires each piece of information from the vehicle interior sensor 12A and the vehicle exterior sensor 12B (step St301). Here, each piece of information is the air conditioning information, the position information, and the weather information.

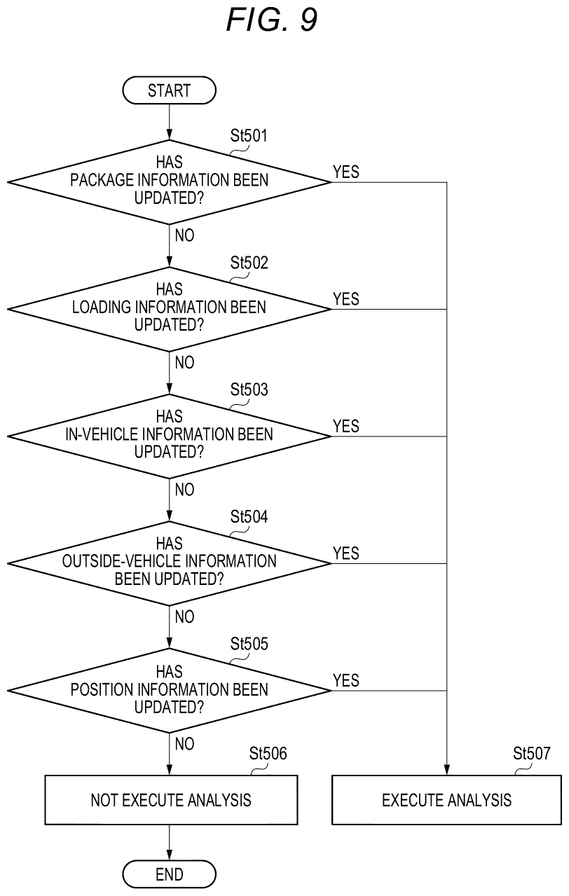

The simulation device 20 determines whether to execute simulation (step St302). The process of step St302 will be described in detail with reference to FIG. 9.

When it is determined that the simulation is not to be executed (NO in step St302), the simulation device 20 executes the process of step St301 again.

When it is determined that the simulation is to be executed (YES in step St302), the simulation device 20 executes the simulation (step St303). Here, the simulation executed by the simulation device 20 is as follows. First, the simulation model setting unit 23A sets a simulation model using the analyzed loading information. The simulation unit 23B calculates a control parameter using the set simulation model and the information acquired in the process of step St301. The verification unit 23C executes an optimization process using the calculated control parameter and the analyzed new loading information to optimize the control parameter.

The simulation device 20 determines the control parameter based on the process of step St303 (step St304).

The simulation device 20 transmits the control parameter to the air conditioning control device 10 (step St305).

Accordingly, the simulation device 20 can calculate an optimum control parameter based on the air conditioning information, the position information, the weather information, and the loading information. The air conditioning control device 10 can keep the package BA cool in an optimum air conditioning environment based on the control parameter acquired from the simulation device 20.

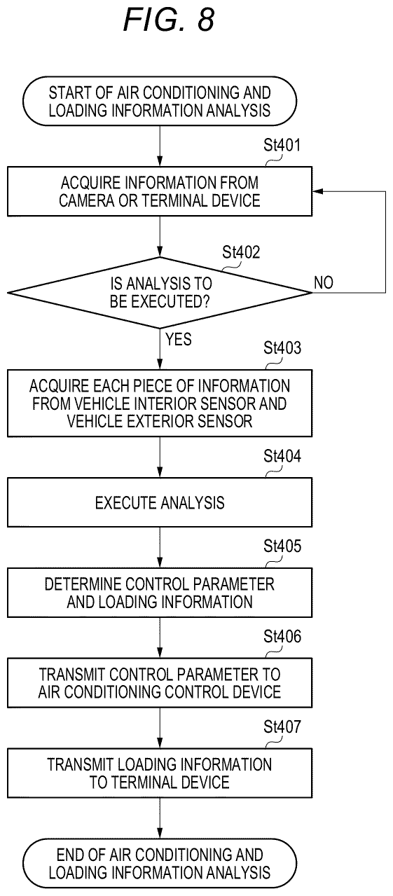

Next, a process of analyzing the loading information and the control parameter will be described with reference to FIG. 8. FIG. 8 is a flowchart of the process of analyzing the loading information and the control parameter. Each process of the flowchart in FIG. 8 is executed by the simulation device 20. In addition, the flowchart in FIG. 8 is an example of the process of the “air conditioning and loading information simulation” in FIG. 5.

The simulation device 20 acquires information from the camera 11 or the terminal device 30 (step St401). The simulation device 20 acquires a captured image as the information acquired from the camera 11. The simulation device 20 detects a position of the package BA in the package compartment P from the acquired captured image using a known technique such as image recognition. The simulation device 20 acquires, from the terminal device 30, information on a package unloaded from the package compartment P or information on a loaded package.

The simulation device 20 determines whether to execute simulation (step St402). The process of step St402 will be described in detail with reference to FIG. 9.

When it is determined in the process of step St402 that the simulation is not to be executed (NO in step St402), the simulation device 20 executes the process of step St401 again.

When it is determined in the process of step St402 that the simulation is to be executed (YES in step St402), the simulation device 20 acquires each piece of information from the vehicle interior sensor 12A and the vehicle exterior sensor 12B (step St403). Here, each piece of information is the air conditioning information, the position information, and the weather information.

The simulation device 20 executes the simulation using the loading information, the information acquired in the process of step St401, and the information acquired in the process of step St403 (step St404). Here, the simulation executed by the simulation device 20 is as follows. First, the simulation model setting unit 23A sets a simulation model using the analyzed loading information. The simulation unit 23B calculates a control parameter and analyzes new loading information using the set simulation model, the information acquired in the process of step St401, and the information acquired in the process of step St403. The verification unit 23C executes an optimization process using the calculated control parameter and the analyzed new loading information to optimize the control parameter and the loading information.

The simulation device 20 determines the control parameter and the loading information based on the process of step St404 (step St405).

The simulation device 20 transmits the control parameter to the air conditioning control device 10 (step St406).

The simulation device 20 transmits the loading information to the terminal device 30 (step St407).

The process of the flowchart in FIG. 8 is executed, for example, in a case where loading and unloading of the package BA occurs at a transportation point or the like. The simulation device 20 can calculate optimum loading information and control parameter according to a change in the package BA in the package compartment P. Accordingly, the air conditioning control device 10 can execute optimum air conditioning control even in a case where there is a change in the package BA in the package compartment P.

Next, a process related to whether execution of simulation is necessary will be described with reference to FIG. 9. FIG. 9 is a flowchart of the process related to whether the execution of simulation is necessary. Each process of the flowchart in FIG. 9 is executed by the simulation device 20. The process related to whether the execution of simulation is necessary illustrated in FIG. 9 corresponds to the process of step St302 in FIG. 7 and the process of step St402 in FIG. 8.

The simulation device 20 determines whether the package information has been updated (step St501). The package information is updated, for example, before the vehicle TR departs for transportation and at a transportation point. The simulation device 20 determines whether the package information has been updated based on the package information acquired from the WMS 40, the captured image acquired from the camera 11, or an input signal from the terminal device 30. When it is determined that the package information has been updated (YES in step St501), the simulation device 20 executes simulation (step St507). The simulation executed when the simulation device 20 determines that the package information has been updated is the loading information simulation or the air conditioning and loading information simulation.

When it is determined that the package information has not been updated (NO in step St501), the simulation device 20 determines whether the loading information has been updated (step St502). The loading information is updated, for example, before the vehicle TR departs for transportation and at a transportation point. The simulation device 20 determines whether the loading information has been updated based on the captured image acquired from the camera 11 or the input signal from the terminal device 30.

When it is determined that the loading information has been updated (YES in step St502), the simulation device 20 executes simulation (step St507). The simulation executed when the simulation device 20 determines that the loading information has been updated is the loading information simulation or the air conditioning and loading information simulation.

When it is determined that the loading information has not been updated (NO in step St502), the simulation device 20 determines whether information in the vehicle (hereinafter, referred to as in-vehicle information) has been updated (step St503). Here, the in-vehicle information is information such as the temperature and the humidity of the package compartment P. The simulation device 20 determines whether the in-vehicle information has changed based on the air conditioning information acquired from the vehicle interior sensor 12A. The simulation device 20 may determine that the in-vehicle information has been updated in a case where the temperature in the vehicle changes by X° C. or more. Here, X° C. may be a predetermined fixed value, or may be a value that changes depending on the package information, the position information, the weather information, or the like.

When it is determined that the in-vehicle information has been updated (YES in step St503), the simulation device 20 executes simulation (step St507). The simulation executed when the simulation device 20 determines that the in-vehicle information has been updated is the air conditioning simulation.

When it is determined that the in-vehicle information has not been updated (NO in step St503), the simulation device 20 determines whether information outside the vehicle (hereinafter, referred to as outside-vehicle information) has been updated (step St504). Here, the outside-vehicle information is the weather information. The simulation device 20 determines whether the outside-vehicle information has changed based on the weather information acquired from the vehicle exterior sensor 12B.

When it is determined that the outside-vehicle information has been updated (YES in step St504), the simulation device 20 executes simulation (step St507). The simulation executed when the simulation device 20 determines that the outside-vehicle information has been updated is the air conditioning simulation.

When it is determined that the outside-vehicle information has not been updated (NO in step St504), the simulation device 20 determines whether the position information has been updated (step St505). The simulation device 20 determines whether the position information has been updated based on the position information acquired from the vehicle interior sensor 12A. For example, in a case where the position information matches position information of a target point of the transport route information, the simulation device 20 determines that the position information has been updated. The simulation device 20 may treat a change in position information in movement of the transport route information between respective points as that the position information has not been updated in the process of step St505. That is, the simulation device 20 may determine that the position information has been updated when the transport route information arrives at the respective points.

When it is determined that the position information has been updated (YES in step St505), the simulation device 20 executes simulation (step St507). The simulation executed when the simulation device 20 determines that the position information has been updated is the air conditioning and loading information simulation.

When it is determined that the position information has not been updated (NO in step St505), the simulation device 20 does not execute the simulation (step St506).

Accordingly, the simulation device 20 can calculate an optimum control parameter each time in accordance with a change in the package information, the loading information, the in-vehicle information, the outside-vehicle information, the position information, or the like during transportation. The air conditioning control device 10 can maintain the optimum air conditioning control during transportation in accordance with the control parameter.

### Summary of Present Embodiment

The following techniques are disclosed according to the above description of the present embodiment.

### <Technique 1>

A simulation device (for example, the simulation device 20) according to the present embodiment includes a communication interface (for example, the communication I/F 21) that receives package information on a package in a vehicle and sensor information from at least one sensor (for example, the vehicle interior sensor 12A or the vehicle exterior sensor 12B) attached to the vehicle, and a processor (for example, the processor 23) that executes air conditioning simulation using the received package information and sensor information and transmits an air conditioning control signal for controlling an air conditioner (for example, the air conditioner 16) provided in the vehicle to the air conditioner.

Accordingly, the simulation device according to the present embodiment can execute air conditioning simulation in consideration of information on the package placed in the vehicle and information from the sensor attached to the vehicle. By transmitting an analyzed air conditioning control signal to the air conditioner, the simulation device can cause the air conditioner to execute optimum cooling control corresponding to a loading state of the package in the package compartment in which the package is placed. Thus, the simulation device can realize the optimum cooling control corresponding to the loading state of the package.

### <Technique 2>

In the simulation device according to the technique 1, the processor executes the air conditioning simulation in a case where the sensor information has been updated.

Accordingly, the simulation device according to the present embodiment can realize optimum cooling control in accordance with a change in environment in the vehicle.

### <Technique 3>

In the simulation device according to the technique 1 or 2, the processor executes the air conditioning simulation in a case where the package information has been updated.

Accordingly, the simulation device according to the present embodiment can realize optimum cooling control in accordance with a change in the package in the vehicle (for example, a package is loaded on the vehicle or taken out from the vehicle).

### <Technique 4>

In the simulation device according to any of the techniques 1 to 3, the processor acquires transport route information on a transport route of the vehicle and position information of the vehicle via the communication interface, and executes the air conditioning simulation in a case where the position information matches position information of a target point of the transport route information.

Accordingly, the simulation device according to the present embodiment can execute the air conditioning simulation when the vehicle arrives at a target point of the transport route information. That is, the simulation device calculates an optimum control parameter in consideration of arrangement and the number of packages in the package compartment that have been changed due to loading and unloading of the package at the target point. Accordingly, the simulation device can realize the optimum cooling control corresponding to the loading state of the package.

### <Technique 5>

In the simulation device according to any of the techniques 1 to 4, the processor acquires vehicle information on a size and a shape of a space in which the package of the vehicle is placed, acquires transport route information on a transport route of the vehicle via the communication interface, and analyzes loading information on a layout in which the package is loaded using the package information, the transport route information, and the vehicle information.

Accordingly, the simulation device according to the present embodiment can realize the optimum cooling control in consideration of the package information, the transport route information, and the vehicle information. For example, the simulation device can cause the air conditioning control device to execute the optimum air conditioning control in which a state of the package does not deteriorate based on a management temperature of a package to be transported, a transport distance, and a size of the package compartment.

### <Technique 6>

In the simulation device according to any of the techniques 1 to 5, the processor acquires a captured image of a camera attached to the vehicle and updates a simulation result of the loading information using the captured image.

Accordingly, the simulation device according to the present embodiment can analyze optimum loading information in accordance with a situation of the package actually placed in the package compartment (for example, the number of packages and a ratio thereof occupying the package compartment). Accordingly, the simulation device can cause the air conditioning control device to execute the air conditioning control based on the updated loading information such that the package compartment is in an optimum air conditioning environment even in a case where the situation of the package in the package compartment is changed.

### <Technique 7>

In the simulation device according to any of the techniques 1 to 6, the communication interface is communicably connected to a terminal device owned by a driver of the vehicle, and the processor updates, in a case where the updated package information is acquired from the terminal device via the communication interface, a simulation result of the loading information using the updated package information.

Accordingly, the simulation device according to the present embodiment can analyze the optimum loading information based on information on the package input by the user. The simulation device can analyze the loading information in accordance with the information on the package loaded on the vehicle or the package taken out from the vehicle, and cause the air conditioning control device to execute the optimum air conditioning control based on the updated loading information.

### <Technique 8>

In the simulation device according to any of the techniques 1 to 7, the processor analyzes the air conditioning control signal based on the loading information.

Accordingly, the simulation device according to the present embodiment can execute the optimum air conditioning simulation corresponding to the situation of the package placed in the vehicle (the arrangement of the package, the ratio of the packages occupying the package compartment, the height of the loaded package, and the like).

### <Technique 9>

In the simulation device according to any of the techniques 1 to 8, the package information is information on a size, a transport destination, and a management temperature of the package.

Accordingly, the simulation device according to the present embodiment can execute the optimum air conditioning simulation in consideration of the size, the transport destination, and the management temperature of the package. The simulation device can prevent, for example, excessive cooling of the package or deterioration of the package due to insufficient cooling.

### <Technique 10>

In the simulation device according to any of the techniques 1 to 9, the sensor information is at least one piece of information on a temperature or humidity inside the vehicle, information on a wind speed or a wind direction of wind output from the air conditioner, and information on a temperature, a wind direction, a wind speed, or solar radiation outside the vehicle.

Accordingly, the simulation device according to the present embodiment can execute the optimum air conditioning simulation in consideration of the air conditioning information and the weather information.

### <Technique 11>

In the simulation device according to any of the techniques 1 to 10, the air conditioning control signal is a control signal for controlling a temperature, a wind speed, or a wind direction of wind output from the air conditioner.

Accordingly, the simulation device according to the present embodiment can realize an optimum air conditioning environment of the package compartment by causing the air conditioning control device to control the temperature, the wind speed, or the wind direction of the wind output from the air conditioner.

Although the embodiment has been described above with reference to the accompanying drawings, the present disclosure is not limited to such an embodiment. It is apparent to those skilled in the art that various changes, modifications, substitutions, addition, deletions, and equivalents can be conceived within the scope described in the claims, and it is understood that the scope of the present disclosure includes these. In addition, components in the embodiment described above may be combined freely in a range without deviating from the spirit of the invention.

### INDUSTRIAL APPLICABILITY

The techniques of the present disclosure are useful as a simulation device, a simulation method, and an air conditioning control system that realize optimum cooling control corresponding to a loading state of a package.

What is claimed is:

1. A simulation device, comprising:
a communication interface configured to receive package information on a package in a vehicle and sensor information from at least one sensor attached to the vehicle, and
a processor configured to execute air conditioning simulation using the received package information and sensor information and transmit an air conditioning control signal for controlling an air conditioner provided in the vehicle to the air conditioner.

2. The simulation device according to claim 1, wherein
the processor is configured to execute the air conditioning simulation in a case where the sensor information is updated.

3. The simulation device according to claim 1, wherein
the processor is configured to execute the air conditioning simulation in a case where the package information is updated.

4. The simulation device according to claim 1, wherein
the processor is configured to
acquire transport route information on a transport route of the vehicle and position information of the vehicle via the communication interface, and
execute the air conditioning simulation in a case where the position information matches position information of a target point of the transport route information.

5. The simulation device according to claim 1, wherein
the processor is configured to
acquire vehicle information on a size and a shape of a space in which the package of the vehicle is placed, and acquire transport route information on a transport route of the vehicle via the communication interface, and
analyze loading information on a layout in which the package is loaded using the package information, the transport route information, and the vehicle information.

6. The simulation device according to claim 5, wherein
the processor is configured to acquire a captured image of a camera attached to the vehicle, and update a simulation result of the loading information using the captured image.

7. The simulation device according to claim 5, wherein
the communication interface is communicably connected to a terminal device of a user of the vehicle, and
the processor is configured to update, in a case where updated package information is acquired from the terminal device via the communication interface, a simulation result of the loading information using the updated package information.

8. The simulation device according to claim 5, wherein
the processor is configured to execute air conditioning simulation based on the loading information.

9. The simulation device according to claim 1, wherein
the package information is information on a size, a transport destination, and a management temperature of the package.

10. The simulation device according to claim 1, wherein
the sensor information is at least one piece of information on a temperature or humidity inside the vehicle, information on a wind speed or a wind direction of wind output from the air conditioner, and information on a temperature, a wind direction, a wind speed, or solar radiation outside the vehicle.

11. The simulation device according to claim 1, wherein
the air conditioning control signal is a control signal for controlling a temperature, a wind speed, or a wind direction of wind output from the air conditioner.

12. A simulation method, comprising:
receiving package information on a package in a vehicle and sensor information from at least one sensor attached to the vehicle, and
executing air conditioning simulation using the received package information and sensor information and transmitting an air conditioning control signal for controlling an air conditioner provided in the vehicle to the air conditioner.

13. An air conditioning control system, comprising:
a simulation device including a communication interface configured to receive package information on a package in a vehicle and sensor information from at least one sensor attached to the vehicle, and a processor configured to execute air conditioning simulation using the received package information and sensor information and optimize an air conditioning control signal for controlling an air conditioner provided in the vehicle, and
an air conditioning control device configured to control the air conditioner based on the air conditioning control signal received from the simulation device.
